(19) United States
(12) Patent Application Publication
(10) Pub. No.: US 2014/0354816 A1
(43) Pub. Date: Dec. 4, 2014

(54) Peripheral Monitoring Device for Transportation Vehicle

(71) Applicant: Hitachi Construction Machinery Co., Ltd., Bunkyo-ku, Tokyo (JP)

(72) Inventors: Yoshihiro Inanobe, Tsuchiura-shi (JP); Yoichi Kowatari, Tsuchiura-shi (JP); Hidefumi Ishimoto, Tsuchiura-shi (JP)

(21) Appl. No.: 14/377,028

(22) PCT Filed: Feb. 5, 2013
(86) PCT No.: PCT/JP2013/052573

§ 371 Date: Aug. 6, 2014

(30) Foreign Application Priority Data
Feb. 7, 2012 (JP) 2012-023843

(51) Int. Cl. B60R 1/00; H04N 7/18

(52) U.S. Cl. CPC B60R 1/002; H04N 7/181; B60R 2300/105; B60R 2300/602; B60R 2300/802
USPC 348/148

(57) ABSTRACT

This invention comprises, for the sake of improving the safety at the time of traveling a transportation vehicle by displaying an image corresponding to the traveling direction of the dump truck 1, cameras 4B, 4L and 4R having the field of visions at least rear side, left side and right side of the dump truck 1, respectively, a monitor 14 disposed in an operator's cab 7 of the dump truck 1, the operator's cab 7 is further comprises a shift lever 21 for operating the forward and rearward traveling direction, a vehicle controller20 and a display controller 30 being also provided for displaying one or plurality of camera image on the monitor in accordance with the traveling direction of the dump truck 1, on the basis of steering information of left or right traveling direction of the dump truck 1 and information from the shift lever 21.

### FIELD OF THE INVENTION

The present invention relates to transportation vehicle for carrying subjects such as earth and soil or the like, more particularly to peripheral monitoring device for transportation vehicle to survey around the transportation vehicle.

### DESCRIPTION OF THE BACKGROUND ART

As typical transportation vehicle, dump truck has a vehicle body frame and a platform (vessel) adapted to lift up and sink down thereto, the vessel is so designed as to carry massive transporting subjects such as crushed rock and stone or earth and soil. The subjects to be carried are conveyed, to a collection space and are discharged at a designated place. At the time of discharging earth and soil loaded from the vessel, the dump truck is moved backwardly and stopped at The designated discharging place. Then, the vessel is tilted for discharging the earth and soil or the like. After completion of discharging, the vessel is restored to the original position, and the dump truck travels the forward direction.

Although the forward field of vision visual field is available sufficiently for an operator boarded in the operator's cab, backward direction is almost blind for eye of the operator so that the backward direction cannot be confirm the situation by the operator. Therefore, a camera (rear side camera) is provided at the rear side field and the camera image of the rear side camera is displayed on a monitor in the operator's cab. Thereby, the rear side situation can be recognized in real time.

Technology to display on a rear side image is disclosed in Patent Document 1, wherein a monitor is provided on an operator's cab to display the image of a rear side camera. According to the technology of the Patent Document 1, the rear side camera is disposed at a position free from stuck of dust or the like which is brought about the rear wheel tire, and displays view image acquired by the camera on the monitor (rear view monitor). And the camera image of the rear side direction is displayed on the monitor when a shift lever is operated at a position to drive backward direction.

### PRIOR ART DOCUMENT

### Patent Document

Kokai Publication. JP 2011-199392 A1

### SUMMARY OF THE INVENTION

### Problem to be solved by the Invention

The traveling operation of the dump truck is controlled by the operator using the shift lever which is provided in the operator's cab. The shift lever is adapted to change-over to three positions consisting of a rear side direction driving position (R), neutral position (N) and front side direction driving position (F). In addition, a steering handle as a steering mechanism is also provided in the operator's cab, thereby the dump truck is operated to travel by means of the shift lever and the steering mechanism. The dump truck goes forward or backward by operating the shift lever, and in addition the dump truck can travel to turn forwardly right or left, or backwardly right or left.

According so the disclosure of Patent Document 1, merely the rear side field of the dump truck is displayed on the monitor. However, the field of vision cannot sufficiently be attained for the traveling direction merely by the rear side camera, when the steering handle is operated to a larger angle, thus accordingly unable to ensure the safety. In other words, the dump truck goes turn to rearward direction when the larger steering angle of the steering handle is performed, the field of view cannot be secured due to the sideward field becomes dead angle range.

Therefore, the object of the present invention is to improve the safety on travelling a transportation vehicle by displaying an image on a monitor in accordance with traveling direction.

### Means for Solving the Problem

In order to solve the foregoing problem, peripheral monitoring device for transportation vehicle of the present invention comprising: cameras having field of view toward at lease rear side, right side and left side directions of the transportation vehicle; a monitor provided in an operator's cab to display view image from one of the cameras or to display dividedly of plural view images from the plural cameras; a controller for controlling images to be displayed on the monitor; the controller being provided in the operator's cab, and adapted to display one or plural number of camera images in accordance with traveling direction of the transportation vehicle on the basis of shift lever information attained from a shift lever to operate front and rear directions of The transportation vehicle, and steering information as to the transportation vehicle turning to right or left direction.

According to the peripheral monitoring device for transportation vehicle, 3 cameras are mounted at rear side and at right and left sides of the transportation vehicle. One or plural camera images are displayed on the monitor of total three cameras on the basis of steering information and shift lever information. Thereby, the necessary field of view is attained depending upon The traveling direction of the transportation vehicle so that the field of view is reduced dead angle. Accordingly, the safety is secured sufficiently.

Further, the controller is characterized to control, the monitor to display solely a camera image of the rear side camera when the steering angle toward right side or left side direction is smaller than the predetermined angle with respect to the steering information and the shift lever is operated to reverse position, while the monitor screen is divided into two areas to display one area for a camera image of the rear side camera and the other area for one camera image from either right side or left side camera depending upon the steering information when the steering angle toward right, side or left side direction is larger than the predetermined angle and the shift lever is operated to reverse position.

In a case where the transportation vehicle travels rearward straightly, the rear side situation can be precisely conformed by displaying the image of the rear side camera entirely on the monitor. While in a case of turning rearward curved direction, the image from the left or right side camera is displayed in conjunction with the image of the rear side camera from steering information, thereby information being attained broadly in connection with the proceeding direction of the transportation vehicle. However, when the steering angle is not so large, image division into two areas of rear side camera and sideward camera is not performed due to the situation can sufficiently be judged merely by the image from the rear side camera. The foregoing control is automatically performed on the basis of the controller, thereby the monitor being adapted to change-over automatically to display the best image.

Further, the controller has a characteristic feature for implementing to divide the monitor screen into two areas for showing the image from the rear side camera on the one region of the monitor, and the image from either left or right side camera on the other area, provided that the transportation vehicle travels backwardly and the backward traveling speed is higher than the predetermined speed, on the basis of acquired steering information and speed information of the transportation vehicle.

Suitable display information for the sake of the operator can be assured by making determination, on the basis not only the steering angle but taking in conjunction with speed information thereto, whether to display one image on the monitor or to be divided into two display areas.

Further, characteristic feature resides in the controller that the other area is displayed a virtual view point image created by converting respectively into upper view point of the camera images acquired from the above-mentioned cameras.

The virtual view point image (bird's eye image) which is converted image of camera to upper view point can be displayed to look down the surrounding of the transportation vehicle. When the shift lever is operated on the position to travel rearward direction, the monitor is displayed the image of rear side camera and the virtual view point image so as to show the situation of the surroundings of the transportation vehicle and the rearward situation of the transportation vehicle. Thereby, improvement of the safety is assured.

Still further characterizing feature of the controller resides in that, at the time of information about the steering angle of the leftward or rightward direction is smaller than a predetermined angle and the shift lever is in the forward position, the monitor is displayed only a camera image from the camera provided at the forward position of the transportation vehicle, while at the time of information about the steering angle of the left ward or right ward direction is larger than the predetermined angle and the shift lever is in the forward position, the monitor is divided into two areas to display on one area a camera image from a camera provided at the forward position and to display on the other area a camera image from the left side or right side camera on the basis of the steering information.

Due to dead angle portion exists also in the front direction of the transportation vehicle, the camera is provided at the front side. And, in a case where the transportation vehicle is turned toward oblique direction, a suitable image is displayed for the traveling direction of the transportation vehicle on showing an image from the front camera and an image from the left side camera simultaneously on the monitor. Thereby, the safety is improved for the transportation vehicle.

And, the further characterizing feature of the controller resides in that at the time of tilting the vessel to discharge the loaded substances, the monitor is displayed image of the rear side camera.

It is extremely important that the operator recognize the rearward situation at The time of discharging the loaded substance from the vessel. For this reason, the view image from the backward camera is displayed based upon the vessel operating information, thus allowing the operator to understand the rearward situation of the transporting vehicle in the course of discharging loaded substance.

### Effects of the Invention

According to the present invention, one or plural camera images of three cameras are displayed on a monitor on the basis of steering information and shift lever information. Thereby, necessary field of view can be attained depending upon traveling direction with least dead angle. Accordingly, the surrounding situation of a transportation vehicle can be recognized accurately and can be improved safety.

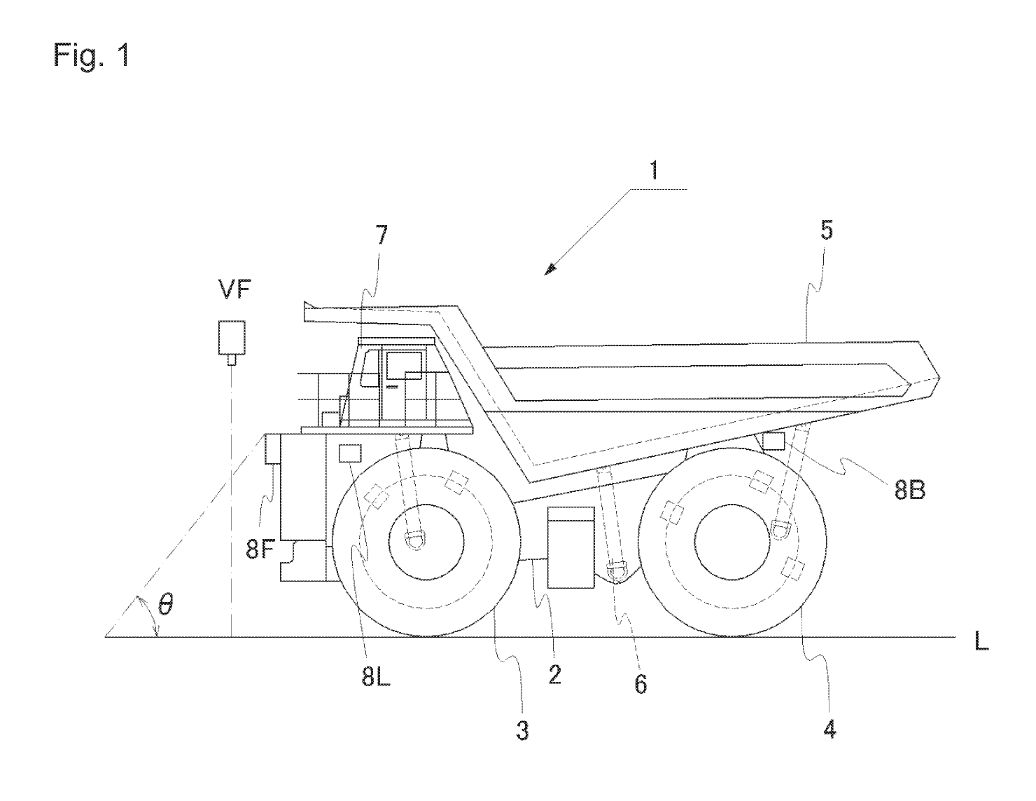

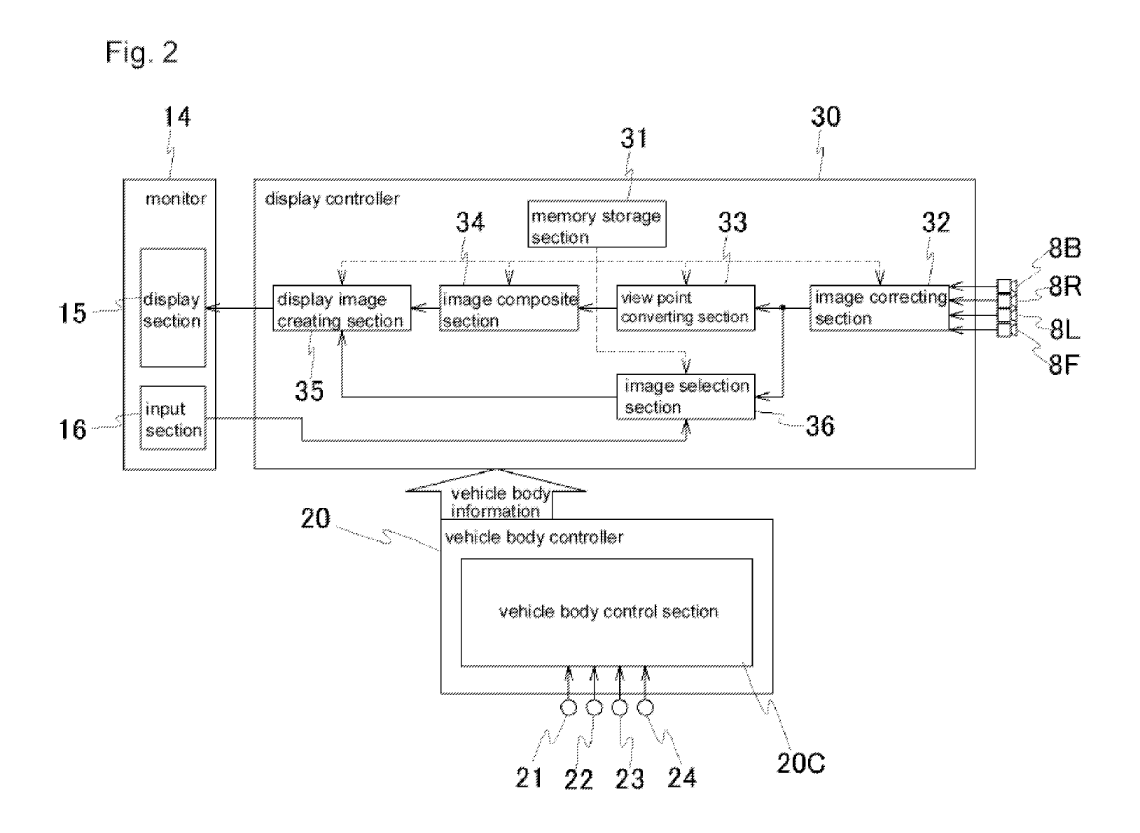

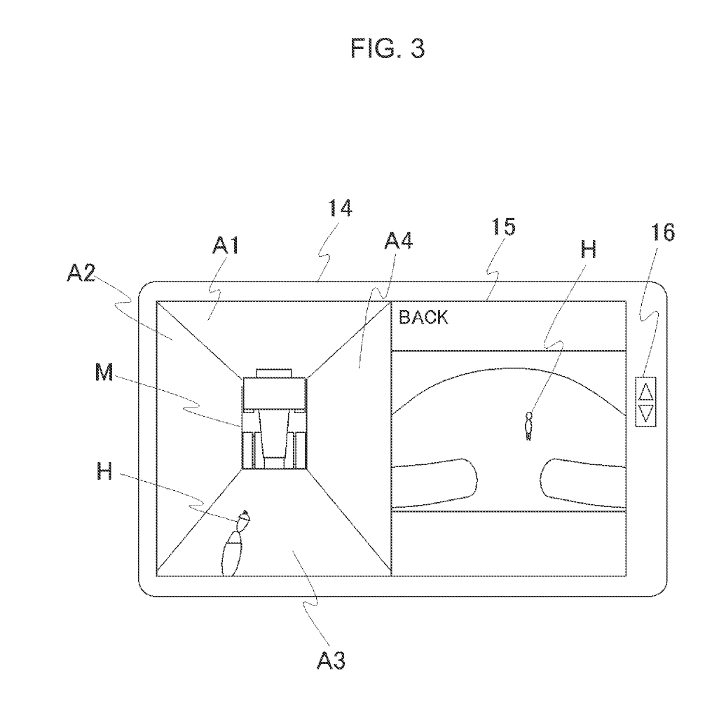

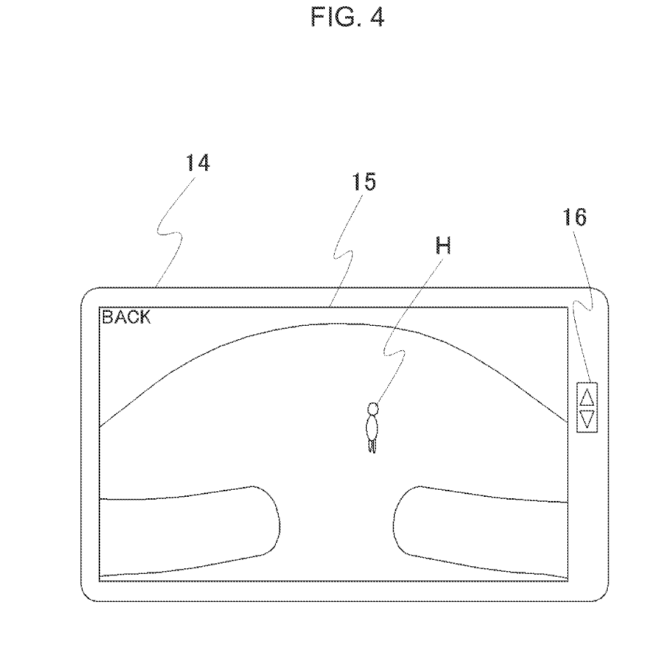

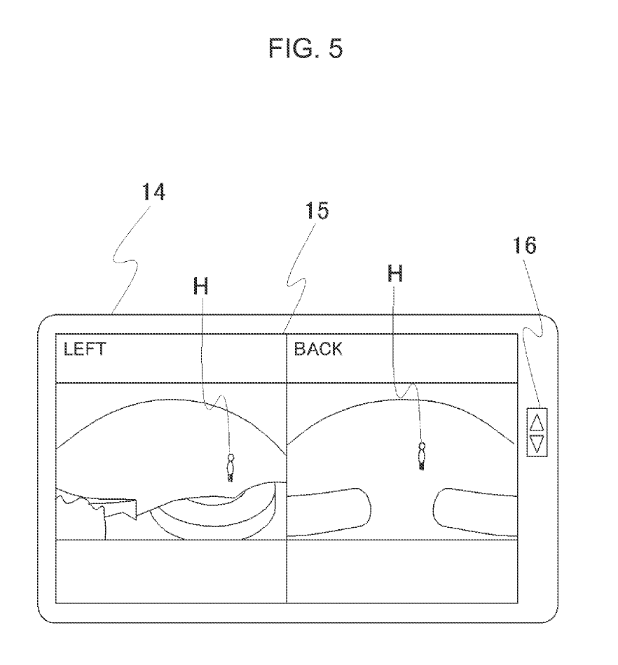

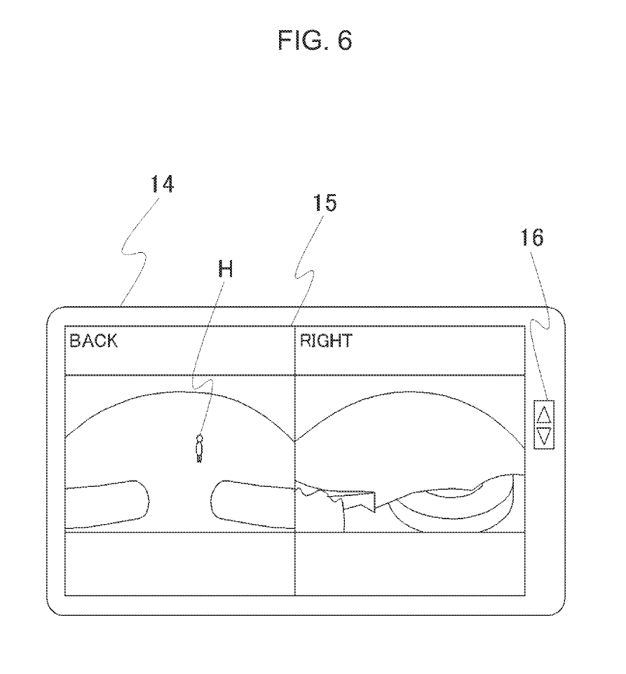

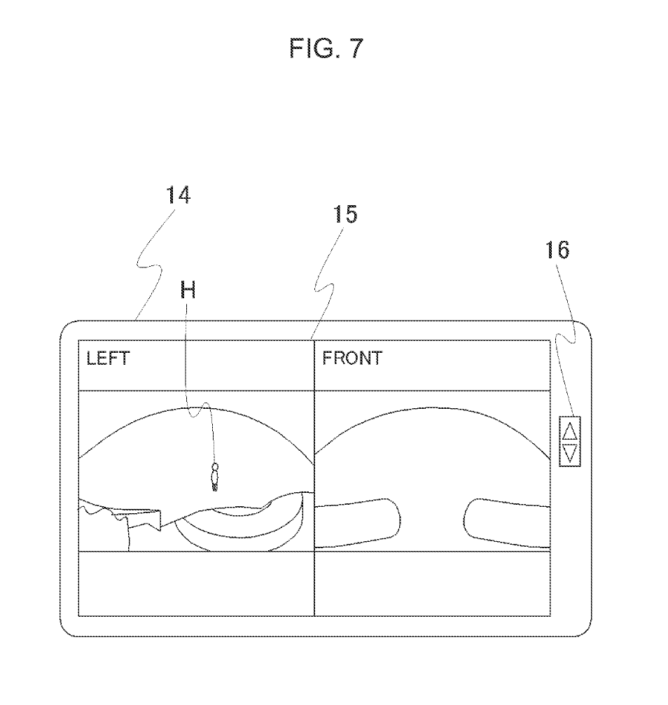

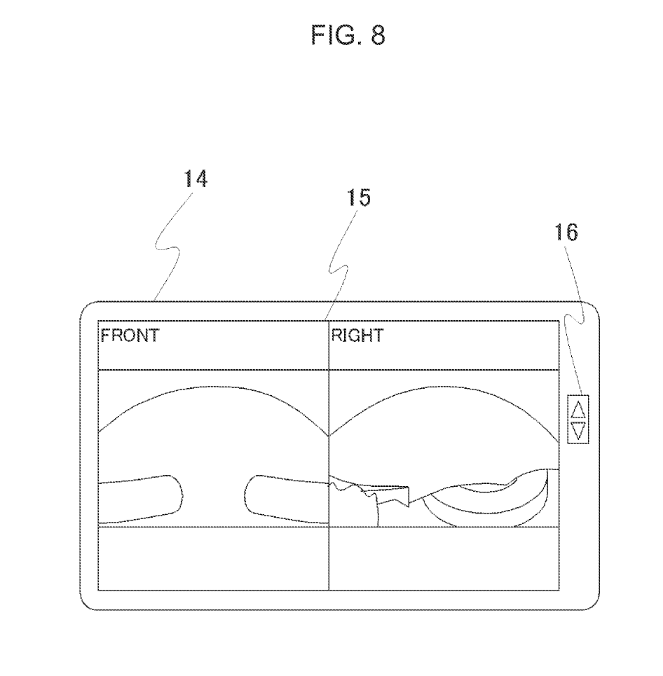

### BRIEF DESCRIPTION OF THE DRAWINGS

[FIG. 1] is a left side elevation view of a dump truck.

[FIG. 2] is a block diagram of a vehicle body controller and display controller.

[FIG. 3] is an example showing a virtual view image and a rear side view image.

[FIG. 4] is an example showing a rear side view image solely.

[FIG. 4] is an example showing a left side a rear side view images.

[FIG. 5] is an example showing a left side and a rear side view image.

[FIG. 6] is an example showing a right side and a rear side view images.

[FIG. 7] is an example showing a left side and a front side view images.

[FIG. 8] is an example showing a right side and a front side view images.

### EMBODIMENT OF THE INVENTION

Hereafter, embodiments of the present invention will be described with reference to the attached drawings. In this case, a dump truck is applied as a transportation vehicle having a vessel (platform). FIG. 1 shows an overall structure of the dump truck 1. The dump truck 1 includes a rigid type and an articulated type, any type can be applied. In the embodiment, “left” means the left side view from an operator's cab, and “right” means the right side view from the operator's cab.

FIG. 1 shows left side elevation view of the dump truck 1, as shown in this drawing, the dump truck 1 comprises a vehicle body frame 2, front wheels 3 and rear wheels 4, a vessel 5, a hoist cylinder 6, an operator's cab 7 and four cameras (front side camera 8F, right side camera 8R, left side camera 8L and back side camera 8B). In this connection, for the reason that the dump truck 1 is looked from left side in FIG. 1, the right side camera 8R does not appeared in FIG. 1, but the right side camera 8R is placed at the opposite side of the left side camera 8L. And, the rear side camera 8B is located at a position free from earth and sand stirred up from the rear wheels 4.

The vehicle body frame 2 constitutes the main body of the dump truck 1, the front side of the vehicle body frame 2 is provided the front wheels 3 and the rear side being provided the rear wheels 4. The vessel 5 is a platform to be loaded earth and sand, ore or the like. Hoist cylinder 6 is provided at the both sides to cause rising up and lowering down the vessel 5 by extending and contracting actions.

The operator's cab 7 is boarded an operator to perform operation of the dump truck 1, a monitor 14 which is hereinafter referred is disposed in the operator's cab 7 to display a predetermined information. And, the operation means for operating the dump truck comprises a shift lever 21 to drive forward direction or rearward direction of the dump truck 1, a steering handle 22 for turn the dump truck 1 to leftward direction or rightward direction, an accelerator pedal to accelerate the dump truck 1 and the like. The operator is boarded in the operator's cab and operates the just-mentioned operation means in order to travel the dump truck 1 for intended direction. In the course of operation, the monitor is confirmed if necessary.

Of the 4 cameras provided for surrounding surveillance of the dump truck 1, the front side camera 8F has a view range of curved, downward direction from the forward direction of the dump truck 1. The right side camera 8R is mounted on the right side portion of the dump truck 1 so that its view range is curved downward direction from the right side of the dump truck 1. The left side camera 8L is mounted on the left side portion of the dump truck 1 so that its view range is directed inclined downward direction from the left side of the dump truck 1. The rear side camera 8B is mounted on the back side portion of the dump truck 1 to have a view range directed inclined downward direction.

Respective cameras (front side camera 8F, right side camera 8R, left side camera 8L and rear side camera 8B) have the view range directed to inclined downward direction, in addition a part of the dump truck 1 (the vehicle body frame 2, the front wheel 3, the rear wheel 5 or the like) being presented in the view area.

The four cameras 8F, 8R, 8L and 8B which are mounted on the dump truck 1 has different view ranges from each other. The respective directions for taking the images of these four cameras 8F, 8R, 8L and 8B are formed to angle of approximately 90 degree with each other. By so constructing, the almost entirely surrounding of the dump truck 1 can be entered into the visibility.

Further, our cameras 8F, 8R, 8L and 8B are directed respectively the field of view toward inclined downward directions, such as shown in FIG. 1 wherein the objective lens of the front side camera of being inclined downwardly the optical axis at an angle of θto the ground level L. As a result, a camera view image is created at she angle θto the ground level L. The planar image having the virtual plane as the ground level L is a virtual view point image created by performing a coordinate conversion that the virtual view point VF has a vertical optical axis (orthogonal plane to the horizontal plane). That is, the virtual view point image is an image looked down to the ground level L from the virtual view point VF. The virtual view point image is a bird's eye image.

FIG. 2 shows a controller consisting of a vehicle body controller 20 and a display controller 30, the display controller 30 is connected to the monitor 14. The monitor 14 is provided in the operator's cab 7, at a position of which is not preventing the visual field of the boarded operator. The monitor 14 consists of a display section 15 to display information and an input section 16 for making input certain information.

The display section 15 is adapted to display view images acquired by the four cameras 8F, 8L, 8R and 8B (camera through image) or the virtual view point image to be converted the view point. Both the camera through image and the virtual view point image consist of image data, and the image data is shown on the display section 15. The display section 15 has a predetermined lateral and horizontal length displaying area, the area being entirely shown the camera through image or the virtual view point image, or otherwise the displaying area being divided into two parts to show respectively different images.

The vehicle body controller 20 consists mainly of a vehicle body control section 20C. The vehicle body control section 20C of the vehicle body controller 20 is inputted the shift lever information, steering information, traveling speed information and vessel operation information. The shift lever information concerns the operation of the shift lever 21 mounted in the operator's cab 7. The shift lever 21 is changed. three positions as forward (F), neutral (N) and back (B). In a case where the shift lever 21 is entered in position (F), the dump truck 1 travels to forward, the dump truck 1 stopped at the position of (N), and the dump truck 1 being traveling to backward in the position of (B). The shift lever information is the information as to the shift lever 21 being entered into the position (F), (N) or (B). The shift lever information is inputted to the vehicle body controller 20.

The steering handle 22 is provided in the operator's cab, the dump truck 1 is adapted to travel to the intended direction by operating the steering handle 22. The steering angle in operating the steering handle 22 is inputted to the vehicle body controller 22 as steering information.

A speed detecting mechanism 23 is mounted for detecting the speed of the dump truck 1 on the basis of the rotational speed of the front wheel 3 and the rear wheel 4 of the dump truck 1, and traveling speed information is prepared by means of the speed detecting mechanism 23. The traveling speed information is inputted to the vehicle body controller 20. Vessel operation information is information as to extending and contracting the hoist cylinder 6 to be controlled by a vessel operation mechanism 24 mounted in the operator's cab 7, upon extended the hoist cylinder 6 bringing to tilt the vessel 5 for discharging the loaded substance. On the contrary, the vessel 5 becomes flat position by contracting the hoist cylinder 6, thus keeping the loaded substance not discharged. The vehicle body controller 20 is adapted to input to the display controller 30 of the shift lever information, steering information, traveling speed information and vessel operation information as the vehicle body information.

The display controller 30 is an apparatus for controlling the contents to be displayed on the monitor 14. The display controller 30 is composed of a memory storage section 31, an image correcting section 32, a view point conversion section 33, an image composite section 34, a display image creating section 35 and an image selection section 36. Further, the display controller 30 is inputted images (camera images) of the rear side camera 8B, the left side camera 8L, the right side camera 8R and the front side camera 8F. Camera images are continuously acquired so that respective camera images can be recognized as real time moving images.

The memory storage section 31 stores various information, such as view angles to take images of the 4 cameras 8F, 8L, 8R and 8F, camera optical system parameters including lens distortion and the like, information as to mounting positions and postures thereof, virtual view point information to convert, the virtual view point images, symbol mark M (mentioned hereinafter) for displaying image, value of scale levels, and so forth. The memory storage section 31 outputs information to the image correction 32, the view point converting section 33, the image composite section 34, the display image creating section 35 and the image selection section 36.

The image correcting section 32 is connected 4 cameras 8F, 8L, 8R and 8F so as to make correction of images acquired, from cameras 8F, 8L, 8R and 8F, such as aberration correction, contrast correction, color correction and the like on the basis of camera optical system parameters stored. in the memory storage section 31. Thus, quality of the image data is improved. The image data after accomplished image correction by the image correcting section 32 is performed output to the view point, converting section 33 and the to the image selection section.

The view point converting section 33 performs to convert the view point to the upper view point images, respectively, on the basis of the image data (front view image, right side view image, left side image and rear side image) which have been completed correction by means of the image correcting section 32. The four cameras 8F, 8L, 8R and 8B are imaging of the field toward inclined downwardly to the ground level L, and then obtained images can be performed image converting treatment, thus the images being converted, the images view from the virtual view point VF (virtual view point image). The virtual view point images are the bird's eye images having upper view point, the obtained bird's eye images being facilitated to recognize surrounding of the dump truck 1 accurately. In this connection, blind area around the dump truck 1 can be eliminated by overlapping the boundaries of the view fields of the four cameras 8F, 8L, 8R and 8B with each other.

The front side view image, as one of the view images consisting of the front side view image, right side view image, left side view image and the rear side view image, is not essentially necessary, because the operator has a visibility from she operator's cab 7, thereby the front side view image can be omitted. On the contrary, other three view images of right side view image, left side view image and the rear side view image are required images (camera through image), and being adapted to create the bird's eye image from the three view these three view images, as well. In view of blind area is existed at the front area of the fore direction of the operator's cab 7, the front view image, however, is displayed for the blind area by mounting the front side camera 8F.

The image composite section 34 brings to compose the image data of four cameras 8F, 8L, 8R and 8B at the divided areas of fore, back, left and right places around a symbol mark M representing the dump truck 1 as the center. For example, as shown in FIG. 3, the center area is shown the symbol mark M of the dump truck 1 and, in positions surrounding thereof disposing at the upper area A1 for the virtual view point front side view image, at the left side area A2 for the virtual view point left side image, at the right side area A3 for the virtual right side image, and as the lower area A1 for the virtual rear side view point image. In FIG. 3, a worker is also shown as H.

Return to FIG. 2, the image correcting section 32 outputs the image data captured by the four cameras 8F, 8L, 8R and 8B to the image selection section 36. These four image data are directly captured in the cameras as camera through images. The image selection section 36 is provided for making selection of one or more image data of the four image data respectively at the front side, right side, left side and rear side, on the basis of the output of the vehicle body information from the vehicle body controller 20. The selected image data is outputted to the display image creating section 35.

The display image creating section 35 creates the image to be displayed on the monitor 14. The image to be displayed may be the bird's eye view image which is composed in the image composite section 34. Further, a single image data to be displayed can be selected from the image selecting section 36. As explained hereinbefore, the display screen of the display section 15 can be divided into plural areas. Therefore, the front and rear image data can be displayed on the divided areas, and displaying the front side, rear side, left side and right side image data on one area, while the other area being displayed the virtual view point view image.

Hereinafter, explanation is made for the operation. The operator operates the dump truck 1 boarded in the operator's cab. At the initial stage, the dump truck 1 is stopped and rotary speed of the front and rear wheels 4 and 5 are zero. Accordingly, information of traveling speed zero is inputted to the vehicle body controller 20. Further, the shift lever is positioned at the neutral position (N) and the dump truck 1 is stopped.

At the foregoing situation, the display controller 20 prosecutes that the front side view image, right side view image, left side view image and rear side view image acquired from the four cameras are subjected to perform aberration correction, contrast correction and the like by means of the image correcting section 32. Then, the four view image, that is, the front side view image, right side view image, left side view image and rear side view image are converted to the virtual view point images in the view point converting section 33. Further, the image composite section 34 performs to compose the front side virtual view point image addressed to the area A1, the left side virtual view point image to the area A2, the right side virtual view point image to the area A3 and the rear side virtual view point image to the area A4 surrounding the symbol mark M of the dump truck 1 as the center position. The virtual view image is thus created.

FIG. 3 shows one type of the display configuration of she monitor 14, wherein the display section 15 is divided into the two areas. On area thereof is shown the bird's eye view image. The bird's eye view image shown on the monitor 14 is an image looked down around the dump truck 1 entirely. The operator can precisely recognize at once the distance between the dump truck 1 and a stationary or movable obstacle (for example, worker or the like) in light of the visibility the bird's eye view image displayed on the display section 15. In the bird' eye view image as shown in FIG. 3, a worker H presents at near place of the dump truck 1.

The virtual view point image is specifically valuable to display during being stopped the dump truck 1. The virtual view point image displayed on the display area 15 of the monitor 14 is visible to the operator so as to confirm any stationary or movable obstacle around the dump truck 1, thereby ensuring to confirm the safety at the time of starting the dump truck 1. In FIG. 3, the worker H is placed at the near position of the dump truck 1, the operator of the dump truck 1 initiates to travel the dump truck 1 with taking in consideration of the presence of the worker H.

While, the other area (another area) in the two area of the display section 15 is shown the rear side through image, that is, the rear side image without converting the view point. The rear side view image is included the worker H and a part of the dump truck 1 (such as the link mechanism ant the like). Accordingly, the display area 15 is displayed the virtual view point image on one divided area of the two areas, while the other area being displayed the rear side camera through image.

Although the virtual view point image and the rear side view image are displayed on the display section 14 in the present embodiment, the left side view image, the right side view image or the front side view image may be displayed in place of the rear side view image. The virtual view point image can also be displayed on the entire area of the display area 15. The most important matter is to pay attention for the around the dump truck 1 at the time of changing the dump truck 1 from the stopped state to the initiation of traveling state, therefore, safety can be assured by displaying the virtual view point image on the display section 15. In addition, the operator can recognize the visual field for traveling direction of the dump truck 1 by displaying the rear side camera through image together with the virtual view point image.

The operator boarded in the operator's cab 7 can drive the dump truck 1 to the arbitral direction in the operation of the shift lever 21 or steering handle 22, further the accelerator pedal. For example, the dump truck 1 is traveled up to the position to be unloaded from the dump truck 1, then performing the operation to unload the earth or sand from the vessel 5. Normally, at the time of unloading of the dump truck 1, the dump truck 1 is moved backwardly to the predetermined unloading position, then discharging the earth or sand from the vessel 5.

Although the field of view is excellent in the front side, the visual field, for rear side is almost blind due to hidden from view by the presence of vessel 5. At the time of moving backward, the dump truck 1 can be moved straight backward direction, but may also be moved backwardly curved direction.

As explained above, the virtual view point image is desirable to show on the display section of the monitor 14 at the time of stopped the dump truck 1. However, since the virtual view point image is an image narrow area about the dump truck 1 as the center, it may be necessary to show image data (camera through image) from the front side camera 8F, the right side camera 8R, the left side camera 8L or the rear side camera 8B. The situation of the traveling direction can be known to the operator by displaying the camera through image on the display section 15.

Then, upon the operating the accelerator pedal by the operator boarded in the operator's cab 7, the traveling speed is accelerated, and the information about traveling is inputted from the vehicle body controller 20 to the display image creating section 36. The display image creating section 36 is controlled to display preferentially the camera through image than the virtual view point image at the time that the traveling speed becomes over the predetermined speed.

When the operator boarded in the operator's cab 7 operates the shift lever to the position (R), the shift lever information is inputted to the display controller 30. The traveling speed information and steering information are also inputted to the display controller 30. In a case where travelling is conducted over predetermined speed at the condition of the shift lever is the position (R) and the steering angle according to the steering information is under the predetermined angle, the image selecting section 36 selects the rear side image, thereby displaying only the camera through image of rear side camera. The content of the display section is shown in FIG. 4. In this case, an indication [BACK] is introduced as the rear side image being displayed.

While, in a case the operator boarded in the operator's cab 7 operates the shift lever into the position (R) and turning the steering handle 22 to left at larger steering angle, the image selecting section 36 selects to display the rear side image and de left side image in response to the shift lever information and the steering information. Therefore, the display section is divided into two areas so that the rear side image is displayed on one area and the left side image is displayed on the other area.

FIG. 5 shows one type thereof, wherein the left side image is shown on one area which is divided in the display section 15. The left side image includes a part of the vehicle (tire or the like). The other area is shown the rear side image. In a case where the dump truck 1 moves curved leftward direction, blind region is unavoidably incurred at the left side in a case where merely the rear side image is displayed. A suitable image is certainly displayed depending upon traveling direction of the dump truck 1 with displaying additionally of the left side image.

In other words, view angle of the rear side camera 8B is restricted to the specific range, therefore, when the dump truck 1 is driving curved backward direction, dead angle incurred to the traveling direction of the dump truck 1 only displayed image form the rear side camera 8B. Therefore, visibility at the traveling direction of the dump truck 1 can certainly be obtained by adding the left side image of the left side camera 8L.

In a case of FIG. 5, the rear side camera 8B shots a worker H and the left side camera 8L shots another worker H. The rear side camera 8B does not show the another worker H which is shown in the left side camera 8L. Therefore, when the dump truck 1 travels leftward curved rear ward, the safety for traveling direction is ensured by displaying the rear side and left side images on the display section 15.

Also applicable in a case of traveling the dump truck 1 to rear but curved rightward direction, when the shift lever is operated to the position (R) and the steering handle 22 is operated right at larger steering angle, the image selecting section 36 selects the rear side image and the right side image. Therefore, the display section 15 is displayed the rear image and the right image. To do so, the sufficiently broader field of view is secured at the time of traveling the dump truck 1 to leftward curved rearward direction.

The same situation is applied for traveling the dump truck 1 toward front ward in curved leftward direction, as shown in FIG. 7, the display image creating section 35 makes selection to display the front image and the left image allotted to respective divided areas by way of the image selecting section 36, thereby facilitating to display on the display section 15 suitably in accordance with the traveling direction. Further, as shown in FIG. 8, in a case of the dump truck 1 traveling forwardly rightward curved direction as well, the front side image and the right side image are displayed on the display section 15.

in summary, cameras 8B, 8L and 8R are mounted at the rear side, left side and right side of dump truck 1, one or plural view images are selected to display in accordance with the traveling direction of the dump truck 1 on the basis of shift lever information and steering information. In a case where the shift lever is entered into (R), it is sufficient to show rear side view image based upon. the view field of the rear side camera ON at the time of small steering angle, while the steering angle becomes over a predetermined angle, the right side view image from the right side camera 8R or the left side view image from the left side camera 8L being displayed alternately or in addition to the rear side view inane of the rear side camera 8B, thereby a wide field of view is attained according to the traveling direction of the dump truck 1. To do so, the safety of the dump truck 1 is secured at the time of traveling.

In this connection, cameras 8B, 8L and 8R which are mounted around the dump truck 1 have lenses respectively of inherent field of angle. In the embodiment of the present invention, since the cameras 8B, 8L and 8R are positioned at the angle of 90 degree with each other, the field of view of respective lens is to have an angle over 90 degree, preferably to use a wide lens having the view angle of near 180 degree. When the dump truck 1 travels in rearward direction, the rear side view image is displayed on the monitor 14.

in the rear side view image, even though the image is partially clear in and around the optical axis, peripheral portion may sometimes not exhibit sufficient clearness due to existence of aberration. To display two divided images is intended not only in a case of unable to secure the field of view but also in consideration of sufficiently clear image at the curvedly rear direction merely by the rear side view image. Therefore, decision as to whether or not to divide the displayed image is made depending upon the degree of steering angle and traveling speed.

In other words, as to whether only the rear side image should be displayed or two images of the rear side and lateral side should be displayed, the conclusion can be arrived at the conclusion on the basis of whether or not can be obtained precise information from the contents of the monitor 14 which is displayed image has sufficient view angle range for confirming safety at the time of traveling toward rear direction. Even though the steering is performed, it is rather preferable to display only the rear side view image at the time of small steering angle for getting a broader image.

In addition, a best image is selected to display on the display section 15 in response to the direction of the dump truck 1 to be travelled, by operating shift lever and steering handle which are necessary to travel the dump truck 1, without performing any specific operation to the operator. Thus accordingly, the object of the present embodiment can be attained without imposing complicated operation to the operator.

And, the virtual view point image is shown for displaying all around the dump truck 1 at the time of stop the dump truck 1, while camera through view image is shown in place of display of the virtual view point image at the time of traveling the dump truck 1 at a predetermined speed. The display section 15 can be shown, therefore, a most suitable image the basis of the situation of the dump truck 1, by changing the mode of the display in accordance with the status variation of the dump truck 1.

In this connection, change-over the display image from the virtual view point image to the camera through image is caused at the time of traveling being accelerated. over a predetermined speed, the predetermined speed can be arbitrary set in advance. Further, not only the rear side view image but also the left side or right side view image is shown at the time that the acceleration handle 22 is operated excess over preset angle, the preset angle can also be arbitrary determined in advance. The predetermined speed and steering angle are stored in the memory storage section 30

When the dump truck 1 is in stopped state (the shift lever is placed the position N), earth or soil loaded on the vessel 5 is discharged. The operation is performed. by the operation lever provided at the vessel 5, and information of vessel operation is inputted in the vehicle body control section 20 when the operator manipulated to tilt the vessel 5 by means of the operation lever.

Upon being inclined the vessel 5, the image selection section 36 selects rear side image from the rear side camera 8B on the basis of vessel operating information inputted from the vehicle body controller 20. That is, the rear side view image is displayed on the display section 15. Since the rear side image is utmost important on discharging earth or sand from the vessel 5, the rear side view image is forced to display on the display section 15, even if the virtual view point image is shown on the display section 15. Thereby, the operator may perform discharging operation of earth or sand with conforming the rear field of view.

As explained above, direction indicators are superposed in the camera. through images of the cameras 8F, 8R, 8L and 8B to indicate respective images as the indication information clearly. Specifically, respective view images are interposed the letter “BACK” for the rear side image, the letter “LEFT” for de left side image, the letter “RIGHT” for the right side image and the letter “FRONT” for the front side image. By so displaying, the operator can intuitively recognize the direction being displayed images. As to the virtual view point image, the image can be judged as the virtual view point image per se at a glance, direction indicator is not set forth, but being capable to superpose.

Although the display section 15 of the monitor 14 is adapted to divide at most two areas in the foregoing embodiment, the divided number may be three or four. For example, the display section 15 is divided into four areas to show the front side image, the left side image, the right side image and the rear side image. These are camera through images to show the traveling direction irrespective of the traveling direction.

Due to the monitor 14 is small in size, a large number of image data are correctively shown on the narrow image area by dividing the display area 14 into four areas and allotted respectively the four areas for front side image, left side image, right side image and rear side image. Thus accordingly, the visibility is deteriorated. Accordingly, it is desired that the image is selected and limited to the suitable image on the basis of traveling direction. On the contrary, it is desired sometimes to display the four images of front side image, left side image, right side image and rear side image, even if deteriorated the visibility. In such a case, the four images can be displayed in accordance with the manual operation by using the input section 6.

### DESCRIPTION OF REFERENCE NUMERALS

1: dump truck
5: vessel
7: operator's cab
8B: rear side camera
8F: front side camera
8L: left side camera
8R: right side camera
14: monitor
15: display section
16: input section
20: vehicle body controller
21: shift lever information
22: steering information
23: traveling speed information
24: vessel operation mechanism
30: display controller
31: memory storage section
32: image correcting section
33: view point conversion section
34: image composite section
35: display image creating section
36: image selection section

1-6. (canceled)

7. Peripheral monitoring device for transportation vehicle comprising:
cameras having field of view toward at least rear side, right side and left side directions of the transportation vehicle;
a monitor provided in an operator's cab to display view image from one of the cameras or to display dividedly of plural view images from the plural cameras;
a controller for controlling of images to be displayed on the monitor;
the controller provided in the operator's cab and, in accordance with shift lever information based upon a shift lever for operating the transportation vehicle to travel toward front and rear directions and steering information to turn the transportation vehicle right or left direction, a screen of the monitor is adapted to display a camera image from the rear side camera in a case of steering angle information to turn right or left direction being smaller than a predetermined angle and the shift lever being operated in rearward direction, while the screen of the monitor is divided into two areas, one area being displayed the camera image from the rear camera and the other area being displayed a camera image from either left or right side image in a case of the shift lever being operated in rearward direction and steering angle information being larger than a predetermined angle.

8. Peripheral monitoring device for transportation vehicle according to claim 7, wherein the controller performing to display on the other area a virtual view point image being converted to upper view point from the images obtained by respective camera images.

9. Peripheral monitoring device for transportation vehicle according to claim 7, wherein the controller performing, in a case where the steering angle of the leftward or rightward direction is smaller than a predetermined angle on the basis of steering information, and the transportation vehicle being traveled forward direction, to display on the monitor screen only the view image from the front side camera provided at the front side of the transportation vehicle, while in a case where the steering angle of the leftward or rightward direction is larger than a predetermined angle obtained from steering information, and the transportation vehicle being traveled forward direction, the monitor is divided into two areas to display on one area a camera image from the front side camera and to display on the other area a camera image from the left side or right side camera in accordance with steering information.

10. Peripheral monitoring device for transportation vehicle according to claim 7, wherein the transportation vehicle comprises a vessel connected to a vehicle body frame to allow rising up and lowering down action, the controller determining to display the rearward camera image on the monitor at the time of tilting the vessel for discharging loaded substance based upon the vessel operating information.
